(19) United States
(12) Patent Application Publication
(10) Pub. No.: US 2026/0021843 A1
(43) Pub. Date: Jan. 22, 2026

(54) EPS CONTROL METHOD AND DEVICE FOR IMPROVING STEERING PERFORMANCE

(71) Applicant: Kookmin University Industry Academy Cooperation Foundation, Seoul (KR)

(72) Inventors: Seung Hoon WOO, Gyeonggi-do (KR); Chan Woo HEO, Busan (KR); Yun Chul HA, Seoul (KR); Seung Uk JEON, Gyeonggi-do (KR)

(21) Appl. No.: 19/270,500

(22) Filed: Jul. 16, 2025

(30) Foreign Application Priority Data
Jul. 18, 2024 (KR) 10-2024-0095311

(51) Int. Cl. B62D 5/04; B62D 6/00

(52) U.S. Cl. CPC B62D 5/0463; B62D 6/00

(57) ABSTRACT

An EPS control device for improving steering performance according to one embodiment of the disclosed invention, comprises a sensing module for sensing information relating to a traveling speed of a vehicle and input information from a driver relating to steering of a steering wheel; a main assist module for controlling a driving part of said vehicle based on the information sensed by said sensing module, a high-frequency assist module for adjusting a high-frequency assist gain based on input information from a driver regarding steering of said steering wheel, and a damping control module for adjusting a damping gain that acts as a resistance to movement of said steering wheel based on input information from a driver regarding steering of said steering wheel.

### CROSS-REFERENCE TO RELATED APPLICATION

This application claims priority to and the benefit of Korean Patent Application No. 10-2024-0095311, filed on Jul. 18, 2024, the disclosure of which is incorporated herein by reference in its entirety.

### BACKGROUND

### Technical Field

The disclosed invention relates to an EPS control method and device for improving steering performance. Specifically, the disclosed invention is about to provide superior steering feel by controlling the damping gain differently in different sections based on the steering angular velocity.

### Background Art

Steering assist systems, also known as steering assist or steering support systems, are technologies designed to help drivers control their vehicles more effectively and safely.

These systems typically utilize sensors, actuators, and computer algorithms that can provide varying levels of assistance depending on the driving situation.

Specifically, the steering assistance system may include sensors to detect various parameters, such as vehicle speed, steering angle, road conditions, driver input, etc.

The steering assistance system may also include an electronic control unit (ECU) programmed to process information measured from the sensors in real time, make decisions based on predefined algorithms, and interpret the data.

These steering assistance systems can provide power steering functions that provide varying levels of assistance based on vehicle speed, lane-keeping assistance functions that keeps the vehicle within its lane, collision avoidance functions that detect potential collisions and adjust the vehicle away from obstacles if the driver does not react, and park assist functions that automatically steer the vehicle to assist with parallel parking or parking in tight spaces.

Therefore, when it comes to the technology of these existing steering assistance systems, there are various efforts underway to provide drivers with a more comfortable steering experience.

However, it is difficult to achieve both improved steering feeling and stability using conventional EPS control systems due to the complex interconnections between the various factors that affect steering feel.

### SUMMARY

### Technical Problem

Accordingly, an EPS control method and device for improving steering performance in accordance with one embodiment of the disclosed invention is an invention created to solve the problems of the prior art described above, and more specifically, to provide an EPS control method and device capable of achieving superior steering feel by applying a variable damping gain based on steering angular velocity.

Further, the EPS control method and device for improving steering performance in accordance with one embodiment of the disclosed invention may provide an EPS control method and device having improved features to achieve both improved steering feel and improved stability by considering influencing factors in a complex relationship with each other.

### Technical Solution

An EPS control device for improved steering performance in accordance with one embodiment of the disclosed invention comprises a sensing module detecting information about a traveling speed of a vehicle and input information from a driver about steering a steering wheel, a main assist module controlling a driving part of the vehicle based on information detected by the sensing module, a high frequency assist module adjusting a high frequency assist gain based on the input information from the driver about steering the steering wheel and a damping control module adjusting a damping gain that acts as a resistance to movement of the steering wheel based on the input information from the driver about steering the steering wheel.

The information about the traveling speed of the vehicle includes a lateral acceleration information of the vehicle, and wherein the information from a driver about steering a steering wheel includes a steering torque information, a steering angle information, and a steering angular velocity information of the steering wheel.

The damping gain is variably controlled based on the steering angular velocity information.

The steering angular velocity information is divided into a first section, second section, and third section, and wherein the damping gain is adjusted based on the steering angular velocity information divided into three sections.

The steering angular velocity information corresponds to the first section, the damping gain increases as the steering angular velocity increases.

The steering angular velocity information corresponds to the second section and the third section, the damping gain decreases as said steering angular velocity increases.

A first reference steering angular velocity information separating the first section from the second section has a value of more than 0.05 rev/s and less than 0.15 rev/s.

A second reference steering angular velocity information separating the second section from the third section has a value of more than 0.25 rev/s and less than 0.35 rev/s.

The high frequency assist module increases the high frequency assist gain as the steering torque passed through the high frequency filter increases, based on the steering torque information of the steering wheel.

An EPS control method for improved steering performance in accordance with one embodiment of the disclosed invention comprises a step of sensing that detects information about a traveling speed of a vehicle and input information from a driver about steering a steering wheel, a step of main assist that controls a driving part of the vehicle based on information detected by the sensing module, a step of high frequency assist that adjusts a high frequency assist gain based on the input information from the driver about steering the steering wheel, and a step of damping control that adjusts a damping gain that acts as a resistance to movement of the steering wheel based on the input information from the driver about steering the steering wheel.

The information about the traveling speed of the vehicle includes a lateral acceleration information of the vehicle, and wherein the information from a driver about steering a steering wheel includes a steering torque information, a steering angle information, and a steering angular velocity information of the steering wheel.

The damping gain is variably controlled based on the steering angular velocity information.

The steering angular velocity information is divided into a first section, second section, and third section, and the damping gain is adjusted based on the steering angular velocity information divided into three sections.

The step of high frequency assist includes a step of increasing the high frequency assist gain as the steering torque passed through the high frequency filter increases, based on the steering torque information of the steering wheel.

An EPS control device for improved steering performance comprises a sensing module detecting a lateral acceleration information of a vehicle, a steering torque information, a steering angle information, and a steering angular velocity information of a steering wheel, a main assist module controlling a driving part of the vehicle based on information detected by the sensing module and a damping control module variably adjusting a damping gain that acts as a resistance to movement of the steering wheel as a value of the steering angular velocity information is varied, and setting the damping gain to zero when the steering angular velocity information has a value of 0 rev/s.

### Advantageous Effects

The EPS control method and device for improving steering performance according to one embodiment of the disclosed invention has the advantage of providing superior steering feel by applying a variable damping gain based on steering angular velocity.

Furthermore, the EPS control method and device for improving steering performance according to one embodiment of the disclosed invention has the advantage of achieving both improved steering feel and stability by considering influencing factors that are in a complex relationship with each other.

Furthermore, the EPS control method and device for improving steering performance according to one embodiment of the disclosed invention has the advantage of being able to utilize the architecture of an existing EPS control system to achieve the goal of improving steering feel.

### BRIEF DESCRIPTION OF THE DRAWINGS

FIG. 1 is a diagram illustrating a graph showing a relationship between steering torque and steering angle, which is one of the metrics that can define steering feel, in an EPS control method and device for improving steering performance according to one embodiment of the disclosed invention.

FIG. 2 is a diagram illustrating a graph showing a relationship between steering torque and lateral acceleration of a vehicle, which is one of the metrics that can define steering feel, in an EPS control method and device for improving steering performance according to one embodiment of the disclosed invention.

FIG. 3 is a diagram illustrating a distortion of the torque response to a sinusoidal steering input due to a trade-off relationship between high frequency assist characteristics and damping characteristics when only the high frequency assist gain is increased, in accordance with an EPS control method and device for improving steering performance in accordance with one embodiment of the disclosed invention.

FIG. 4 is a diagram illustrating a reduction of the stability of the steering wheel due to a trade-off relationship between high frequency assist characteristics and damping characteristics when only the high frequency assist gain is increased, in accordance with an EPS control method and device for improving steering performance in accordance with one embodiment of the disclosed invention.

FIG. 5 is a diagram illustrating a configuration of an EPS control device for improving steering performance in accordance with one embodiment of the disclosed invention.

FIG. 6 is a diagram illustrating a damping gain adjustment graph in an EPS control device for improving steering performance, according to one embodiment of the disclosed invention.

FIG. 7 is a diagram illustrating the response time improvement effect of the disclosed invention in the first section of the damping gain adjustment graph shown in FIG. 6.

FIG. 8 is a diagram illustrating the effectiveness of the disclosed invention in improving steering wheel return ability in the first section of the damping gain adjustment graph shown in FIG. 6.

FIG. 9 is a diagram illustrating the offsetting effect of the high frequency auxiliary gain increase of the disclosed invention in the second section of the damping gain adjustment graph shown in FIG. 6.

FIG. 10 is a diagram illustrating the effectiveness of the disclosed invention in increasing steering response and recoverability in the third section of the damping gain adjustment graph shown in FIG. 6.

FIG. 11 is a flowchart illustrating an EPS control method for improving steering performance in accordance with one embodiment of the disclosed invention.

### DETAILED DESCRIPTION

The embodiments described herein and the configurations illustrated in the drawings are merely preferred examples of the disclosed invention, and there may be various modifications that may be made in lieu of the embodiments and drawings described herein at the time of filing of this application.

In addition, identical reference numerals or symbols in each drawing of this specification designate parts or components that perform substantially the same function.

Further, the terms used herein are for the purpose of describing embodiments and are not intended to limit and/or define the disclosed invention. Expressions in the singular include the plural unless the context clearly indicates otherwise.

As used herein, the terms “including”, “comprising”, or “having” are intended to designate the presence of the features, numbers, steps, operations, components, parts, or combinations thereof described herein, and do not preclude the presence or addition of one or more other features, numbers, steps, operations, components, parts, or combinations thereof.

In addition, as used herein, terms including ordinal numbers, such as “first,” “second,” and the like, may be used to describe various components, but the components are not limited by such terms, and such terms are used only to distinguish one component from another.

For example, a first component may be named as a second component, and similarly, a second component may be named as a first component, without departing from the scope of the present disclosure. The term “and/or” includes any combination of a plurality of related recited items or any one of a plurality of related recited items.

Embodiments of the present invention will now be described in detail with reference to the accompanying drawings.

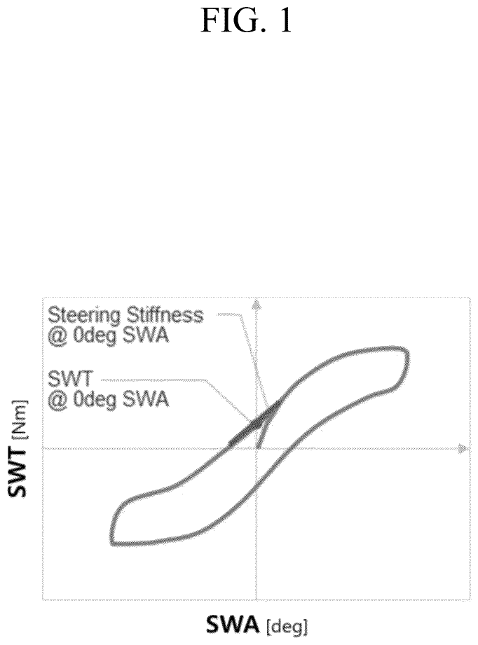

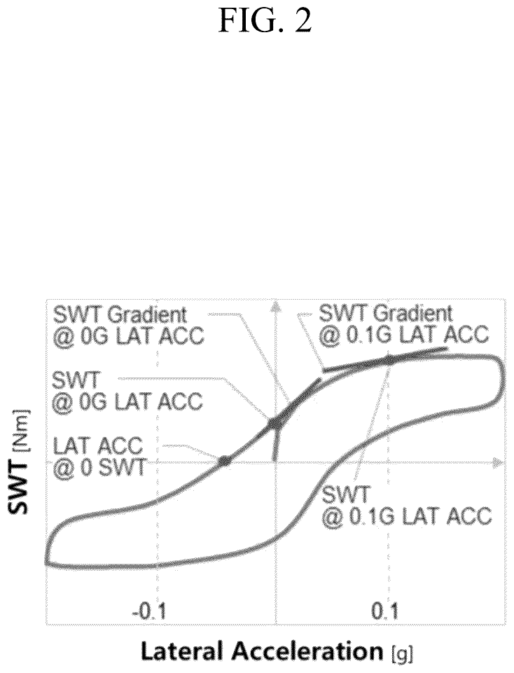

FIG. 1 is a diagram illustrating a graph showing a relationship between steering torque and steering angle, which is one of the metrics that can define steering feel, in an EPS control method and device for improving steering performance according to one embodiment of the disclosed invention. FIG. 2 is a diagram illustrating a graph showing a relationship between steering torque and lateral acceleration of a vehicle, which is one of the metrics that can define steering feel, in an EPS control method and device for improving steering performance according to one embodiment of the disclosed invention.

Referring now to FIG. 1, the relationship between steering torque and steering angle, which is one of the metrics that can define steering feel as it relates to the steering sensation felt by the driver, may be represented as shown in the graph.

More specifically, steering torque can refer to the rotational force that a driver applies to the steering wheel to change the direction of the vehicle.

In other words, steering torque can be defined as the effort exerted by the driver's hands on the steering wheel to overcome resistance and turn the wheels of the vehicle.

Additionally, steering angle can refer to the angle of the front wheels defined relative to the vehicle's longitudinal axis.

In other words, the steering angle means the direction the wheels are pointing, which can indicate the direction the vehicle will be traveling.

Therefore, from the steering torque graph according to steering angle shown in FIG. 1, the steering torque value when the steering angle is 0 degrees and the slope value of the steering torque value when the steering angle increases from 0 degrees can be extracted as important factors for evaluating the steering feel.

Also referring to FIG. 2, the relationship between steering torque and lateral acceleration of the vehicle, which is one of the metrics that can define steering sensation associated with the steering feel felt by the driver, may be represented by the graph shown.

More specifically, steering torque may refer to a rotational force applied by a driver to a steering wheel to change the direction of a vehicle, as described above.

In other words, steering torque can be defined as the effort exerted by the driver's hands on the steering wheel to overcome resistance and turn the wheels of the vehicle.

In addition, the lateral acceleration of a vehicle refers to the acceleration acting in the direction perpendicular to the direction of travel of the vehicle, and is the acceleration applied to the side of the vehicle.

The lateral acceleration of these vehicles is an important parameter for understanding and evaluating the handling dynamics of a vehicle while cornering or driving, and can be measured in meters per second (m/s²) or g-force (1 g=9.81 m/s²).

In addition, lateral acceleration of the vehicle can occur during a turn or change of direction.

In addition, the lateral acceleration of vehicles can be affected by the vehicle's travel speed, the driver's steering input, etc.

Therefore, from the steering torque graph as a function of steering angle shown in FIG. 1, the steering torque magnitude and slope values when the lateral acceleration is 0 g and the steering torque magnitude and slope values when the lateral acceleration is 0.1 g can be extracted as important factors for evaluating the steering feel.

Accordingly, the EPS control method and device for improving steering performance according to one embodiment of the disclosed invention may implement an EPS control system with different settings of various factors, generate the graphs shown in FIGS. 1 and 2 for each vehicle in which the respective control system is implemented, compare them with each other, and provide an optimal EPS control method and device having the best steering feel accordingly.

For example, an EPS control method and device for improving steering performance according to the disclosed invention may provide improved steering feel by lowering the steering torque value when the lateral acceleration is 0 g and increasing the slope of the steering torque value when the lateral acceleration is beyond 0 g. More details in this regard will be discussed later.

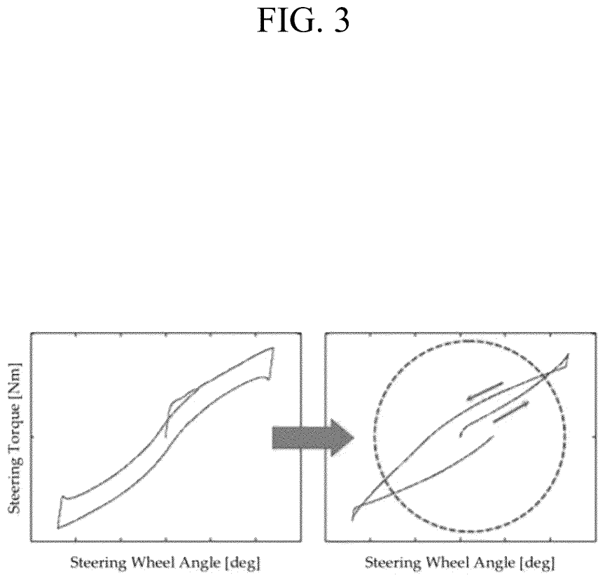

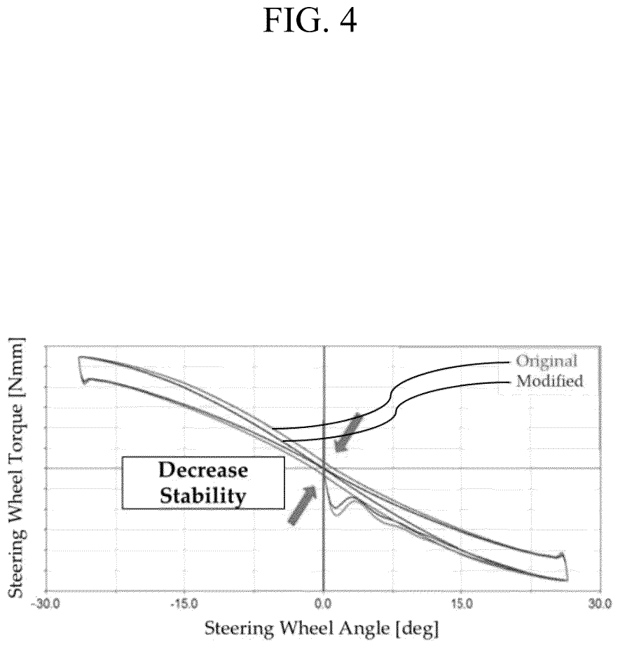

FIG. 3 is a diagram illustrating a distortion of the torque response to a sinusoidal steering input due to a trade-off relationship between high frequency assist characteristics and damping characteristics when only the high frequency assist gain is increased, in accordance with an EPS control method and device for improving steering performance in accordance with one embodiment of the disclosed invention. FIG. 4 is a diagram illustrating a reduction of the stability of the steering wheel due to a trade-off relationship between high frequency assist characteristics and damping characteristics when only the high frequency assist gain is increased, in accordance with an EPS control method and device for improving steering performance in accordance with one embodiment of the disclosed invention.

Referring now to FIG. 3, an EPS control method and device for improving steering performance according to one embodiment of the disclosed invention suffers from the problem described above of not sufficiently offsetting the gradient of the initial steering torque due to initial friction.

Accordingly, the disclosed invention applies a method of increasing a high-frequency auxiliary gain, which is a proportional gain for the high-frequency components generated by applying a high-pass filter to the torque sensor signal when a certain level of steering torque is required due to friction in the initial steering phase.

However, when this high-frequency auxiliary gain becomes large, it distorts the torque response to a sinusoidal steering input, as shown in FIG. 3.

In other words, if only the high-frequency assist gain is increased to secure the steering torque gradient in the initial steering phase, the damping characteristics of the vehicle will be excessively reduced due to the trade-off relationship between the high-frequency assist characteristics and the damping characteristics, and the friction feel will be reduced.

Referring to FIG. 4, in this case, the steering wheel of the vehicle becomes more vulnerable to external forces and its stability is reduced.

More specifically, FIG. 4 shows that the vehicle without adjusting the high frequency auxiliary gain (Original) has a constant thickness steering torque margin for sinusoidal steering input.

However, it can be seen in FIG. 4 that the vehicle with the high-frequency auxiliary gain adjusted (Modified) for initial steering torque slope has a reduced thickness steering torque margin for sinusoidal steering input.

If, to address this, the damping gain, which defines the damping characteristic, is increased, the adjustment of the high frequency auxiliary gain described above becomes irrelevant.

In other words, there is a trade-off between high-frequency assist characteristics and damping characteristics in steering control.

Accordingly, the disclosed invention may provide an EPS control method and device for appropriately setting the high frequency assist characteristics and damping characteristics of a vehicle, which are in a trade-off relationship with each other, to provide improved steering feel.

More specifically, the EPS control method and device for improving steering performance in accordance with one embodiment of the disclosed invention has the technical effect of increasing high frequency auxiliary gain, but with real-time variable control of damping gain based on steering angular velocity to address the torque path twist problem described above, thereby increasing stability. More details in this regard will be described later.

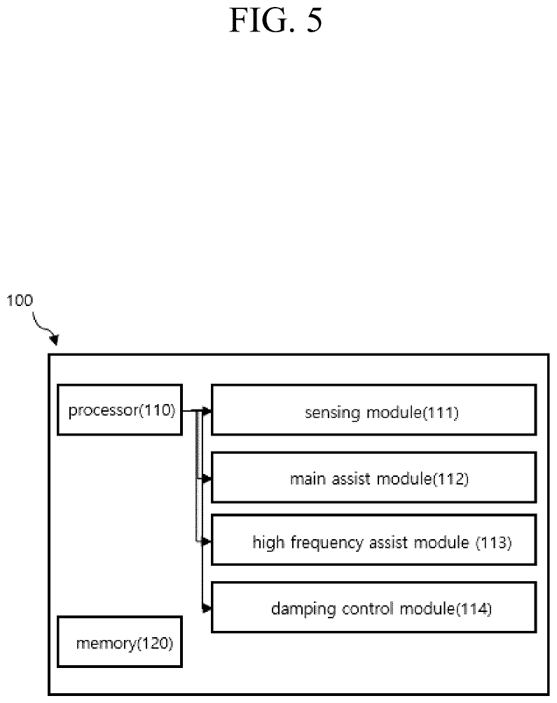

FIG. 5 is a diagram illustrating a configuration of an EPS control device for improving steering performance in accordance with one embodiment of the disclosed invention.

Referring now to FIG. 5, an EPS control device 100 for improving steering performance according to one embodiment of the disclosed invention may include a processor 110 and a memory 120.

More specifically, the processor 110 of the disclosed invention dataries and processes information, and the memory 120 may be configured to store information processed by the processor 110 and derived information.

Such processor 110 and memory 120 may be implemented with at least one of storage media storing programs and data required for the aforementioned operations, and the processor 110 and memory 120 may be implemented on a single chip or on separate chips.

Furthermore, the EPS control device 100 for improving steering performance according to one embodiment of the disclosed invention may be implemented as a variety of devices, for example, as a server.

As used herein, server refers to a conventional server, which is computer hardware on which a program is executed, and which may monitor, control, or facilitate the control of an entire network, such as printer control or file management, or connections to other networks via a mainframe or public network, and the sharing of software resources such as data, programs, and files, or hardware resources such as modems, fax machines, printer sharing, and other equipment.

As used herein, a network refers to a connection structure that enables information exchange between respective nodes, such as a plurality of terminals and servers, and examples of such networks include a local area network (LAN), a wide area network (WAN), the Internet (WWW), a wired or wireless data communication network, a telephone network, a wired or wireless television communication network, and the like. Examples of wireless data communication networks include 3G, 4G, 5G, 3GPP (3rd Generation Partnership Project), 5GPP (5th Generation Partnership Project), LTE (Long Term Evolution), WIMAX (World Interoperability for Microwave Access), Wi-Fi (Wi-Fi), Internet (Internet), LAN (Local Area Network), Wireless LAN (Wireless Local Area Network), WAN (Wide Area Network), PAN (Personal Area Network), RF (Radio Frequency), Bluetooth (Bluetooth) networks, NFC (Near-Field Communication) networks, satellite broadcast networks, analog broadcast networks, and DMB (Digital Multimedia Broadcasting) networks, but it is not limited to this.

Further, the processor 110 of the EPS control device 100 for improving steering performance according to one embodiment of the disclosed invention may include a sensing module 111, a main assist module 112, a high frequency assist module 113, and a damping control module 114.

More specifically, the sensing module 111 of the EPS control device 100 for improving steering performance according to one embodiment of the disclosed invention may detect information about a traveling speed of a vehicle and input information from the driver about steering of the steering wheel.

Specifically, information related to the vehicle's traveling speed may include information about the vehicle's lateral acceleration.

Further, the driver's input information related to steering the steering wheel may include steering torque information, steering angle information, and steering angular velocity information of the steering wheel.

However, the above information is illustrative only and may include information other than that listed above.

Furthermore, the main assist module 112 of the EPS control device 100 for improving steering performance according to one embodiment of the disclosed invention may control the driving part of the vehicle based on information detected by the sensing module 111.

Further, the high frequency assist module 113 of the EPS control device 100 for improving steering performance according to one embodiment of the disclosed invention may adjust the high frequency assist gain based on input information from the driver regarding steering of the steering wheel.

More specifically, the high frequency assist module 113 according to one embodiment of the disclosed invention may increase the high frequency assist gain as the steering torque passed through the high frequency filter increases, based on steering torque information from the steering wheel.

This is a method to increase the high frequency auxiliary gain, which is the proportional gain for the high-frequency components that result from applying a high-pass filter to the torque sensor signal when significant steering torque is required due to friction during the initial steering phase, as described above.

Further, the damping control module 114 of the EPS control device 100 for improving steering performance according to one embodiment of the disclosed invention may adjust the damping gain that acts as a resistance to movement of the steering wheel based on input information from the driver regarding steering of the steering wheel.

More specifically, the damping gain may be variably controlled based on steering angular velocity information, among other driver input information related to steering of the steering wheel sensed by the sensing module 111.

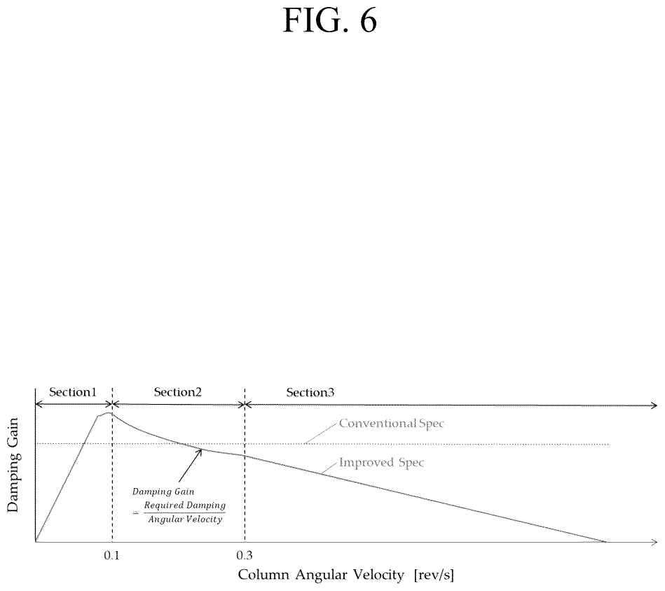

More on this later in the description of FIG. 6.

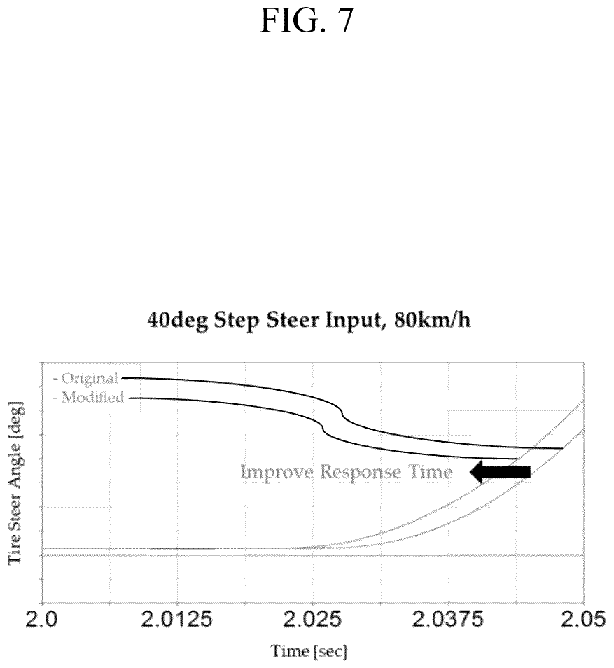

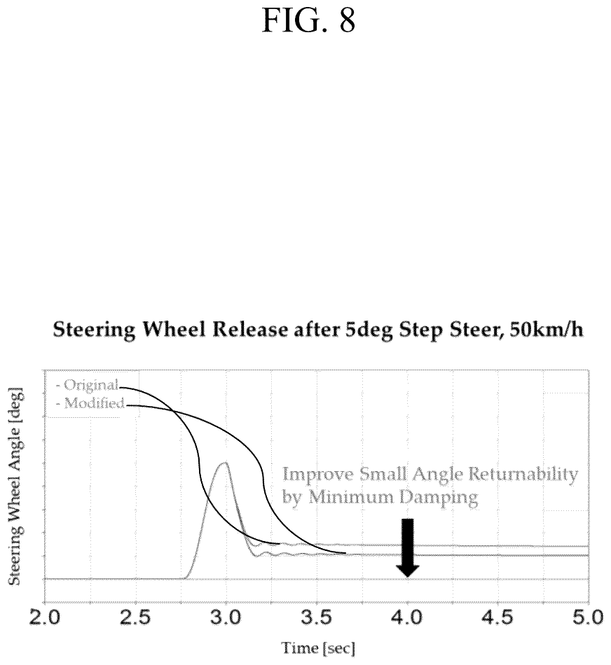

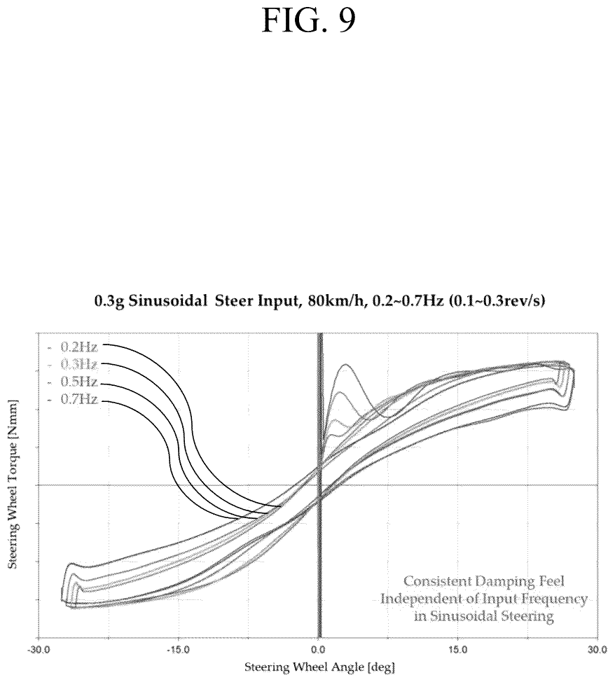

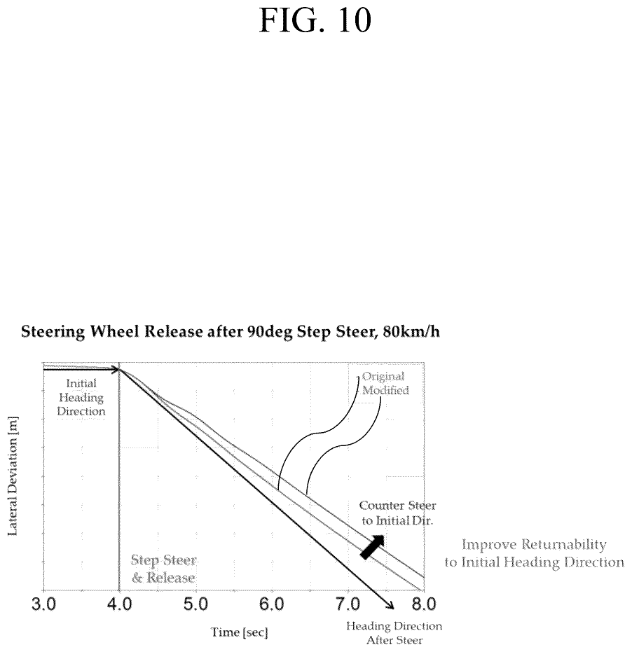

FIG. 6 is a diagram illustrating a damping gain adjustment graph in an EPS control device for improving steering performance, according to one embodiment of the disclosed invention. FIG. 7 is a diagram illustrating the response time improvement effect of the disclosed invention in the first section of the damping gain adjustment graph shown in FIG. 6. FIG. 8 is a diagram illustrating the effectiveness of the disclosed invention in improving steering wheel return ability in the first section of the damping gain adjustment graph shown in FIG. 6. FIG. 9 is a diagram illustrating the offsetting effect of the high frequency auxiliary gain increase of the disclosed invention in the second section of the damping gain adjustment graph shown in FIG. 6. FIG. 10 is a diagram illustrating the effectiveness of the disclosed invention in increasing steering response and recoverability in the third section of the damping gain adjustment graph shown in FIG. 6.

Referring to FIG. 6, the damping control module 114 of the EPS control device 100 for improving steering performance in accordance with one embodiment of the disclosed invention may variably control the damping gain based on steering angular velocity information.

More specifically, the steering angular velocity information of the vehicle for control of the damping control module 114 may be divided into a first section, a second section, and a third section.

Accordingly, the damping control module 114 may adjust the damping gain based on the triplicated steering angular velocity information.

Specifically, the first section may be defined as the section from when the steering angular velocity information starts at 0 rev/s until the first reference steering angular velocity information is reached.

In this case, the first reference steering angular velocity information, which is the basis for distinguishing between the first and second sections, may have a value of more than 0.05 rev/s and less than 0.15 rev/s.

Preferably, the first reference steering angular velocity information, which is the criterion for distinguishing between the first and second sections, may have a value of 0.1 rev/s.

For example, if the steering angular velocity information is in the first section, the damping gain controlled by the damping control module 114 may increase as the steering angular velocity increases.

Further, the second section may be defined as the section from when the steering angular velocity information is the first reference steering angular velocity information to when the second reference steering angular velocity information is reached.

In this case, the second reference steering angular velocity information, which is the basis for distinguishing between the second and third sections, may have a value of more than 0.25 rev/s and less than 0.35 rev/s.

Preferably, the second reference steering angular velocity information, which is the criterion for distinguishing between the second and third sections, may have a value of 0.3 rev/s.

For example, if the steering angular velocity information corresponds to a second section, the damping gain controlled by the damping control module 114 may decrease as the steering angular velocity increases.

Further, the third section may be defined as the section where the steering angular velocity information is greater than or equal to the second reference steering angular velocity information.

For example, if the steering angular velocity information is in the third section, the damping gain controlled by the damping control module 114 may decrease as the steering angular velocity increases.

Therefore, while the conventional case implements a constant damping gain regardless of the value of the steering angular velocity, as shown by the dotted line in FIG. 6, in the case of the disclosed invention, there is a technical effect that the damping gain can be controlled variably according to the steering angular velocity information to improve the steering feel.

In the following, we will describe the simulation results that verify the steering feel improvement for each section with reference to the drawings.

Referring to FIGS. 7 and 8, the damping control module 114 of the EPS control device 100 for improving steering performance according to one embodiment of the disclosed invention may control the damping gain of the first section to increase as the steering angular velocity value increases.

Traditionally, the damping gain is implemented as a constant regardless of the steering angular velocity, which increases the driver's resistance to steering and delays the initial response to fast steering, such as step steering.

However, as shown in FIG. 7, in the case of the EPS control device 100 (modified) for improved steering performance according to one embodiment of the disclosed invention, the tire steering angle increases as the torque required during the initial steering phase is reduced.

Further, in the case of the EPS control device 100 (modified) for improving steering performance according to one embodiment of the disclosed invention, the damping gain may be set to zero when the value of the steering angular velocity information is 0 rev/s.

Thus, the disclosed invention has the technical effect of minimizing the resistance caused by the damping during the initial steering of the driver, thereby minimizing interference with the high frequency assist characteristics.

Furthermore, as shown in FIG. 8, it can be seen that the EPS control device 100 (modified) for improved steering performance in accordance with one embodiment of the disclosed invention exhibits improved steering wheel return capability in situations where the driver's hands are released from the steering wheel.

Referring to FIG. 9, the damping control module 114 of the EPS control device 100 for improving steering performance according to one embodiment of the disclosed invention may control the damping gain of the second section to decrease as the steering angular velocity value increases.

More specifically, for steering from 0.2 Hz, a frequency corresponding to 0.1 rev/s, to 0.7 Hz, a frequency corresponding to 0.3 rev/s, the EPS control device 100 for improving steering performance according to one embodiment of the disclosed invention can implement a damping force that is independent of the value of the input steering angular velocity.

Specifically, the damping control module 114 of the EPS control device 100 for improving steering performance according to one embodiment of the disclosed invention may control the damping gain such that, when a value of the steering angular velocity information is between 0.1 rev/s and 0.3 rev/s, a damping force calculated by multiplying the value of the steering angular velocity information by the damping gain is realized consistently.

Accordingly, the EPS control device 100 for improving steering performance according to one embodiment of the disclosed invention may realize a constant damping force by controlling that the damping gain decreases as the steering angular velocity information is in the second section when the steering angular velocity increases.

As a result, the disclosed invention can eliminate the torque route twist problem when the steering angular velocity information is in the second section, and provide an adequate level of reaction force for fast steering inputs, while not interfering with the high frequency assist characteristics described above.

Referring to FIG. 10, the damping control module 114 of the EPS control device 100 for improving steering performance according to one embodiment of the disclosed invention may control the damping gain of the third section to decrease as the steering angular velocity value increases.

More specifically, the EPS control device 100 according to the disclosed invention can set the damping gain to be lower than the second section when the value of the steering angular velocity information is very high, so as to secure fast steering response and recoverability.

For example, if the steering angular velocity information is very large, such as in the third section, and the high damping gain is maintained, the problem of increased steering torque around 0 deg for sinusoidal steering will exist.

Thus, the EPS control device 100 according to the disclosed invention may control such that the damping gain is reduced as the value of the steering angular velocity information increases when the steering angular velocity information falls in the third section.

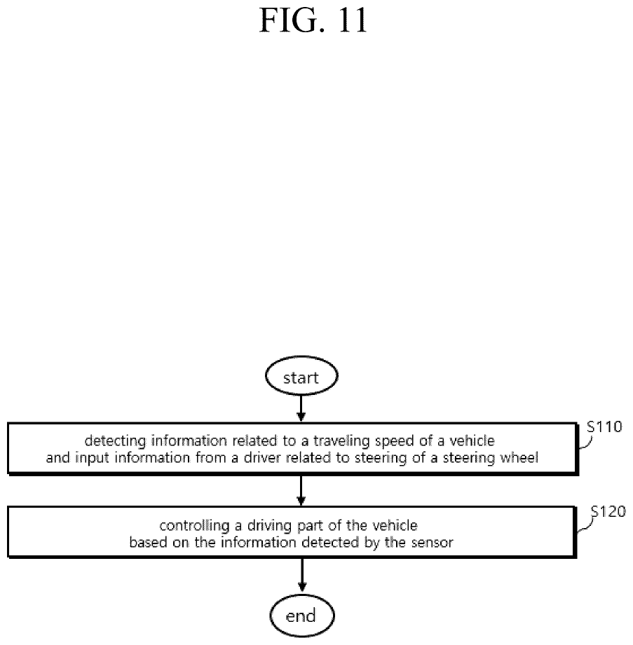

FIG. 11 is a flowchart illustrating an EPS control method for improving steering performance in accordance with one embodiment of the disclosed invention.

Referring now to FIG. 11, an EPS control method for improving steering performance according to one embodiment of the disclosed invention may include a step S110 of detecting information related to a traveling speed of a vehicle and input information from a driver related to steering of a steering wheel.

More specifically, the step S110 of detecting information related to a traveling speed of the vehicle and input information from the driver related to steering of the steering wheel may be performed by the sensing module 111.

Specifically, information related to the vehicle's traveling speed may include information about the vehicle's lateral acceleration.

Further, the driver's input information related to steering the steering wheel may include steering torque information, steering angle information, and steering angular velocity information of the steering wheel.

However, the above information is illustrative only and may include information other than that listed above.

Further, the EPS control method for improving steering performance according to one embodiment of the disclosed invention may include a step S120 of controlling a driving part of a vehicle based on information detected by a sensor.

More specifically, the step S120 of controlling the driving part of the vehicle based on the information detected by the sensors may be performed by the main assist module 112 based on the information input to the sensing module 111.

Further, the step S120 of controlling the driving part of the vehicle based on the information detected by the sensor may include the step of adjusting the high frequency assist gain based on input information from the driver regarding steering of the steering wheel.

More specifically, the step of adjusting the high frequency assist gain based on the driver's input information regarding steering of the steering wheel may be performed by the high frequency assist module 113.

More specifically, the step of adjusting the high frequency assist gain based on the driver's input information regarding steering of the steering wheel may include a step of increasing the high frequency assist gain as the steering torque passed through the high frequency filter increases, based on the steering torque information of the steering wheel.

This is a method to increase the high frequency auxiliary gain, which is the proportional gain for the high-frequency components that result from applying a high-pass filter to the torque sensor signal when significant steering torque is required due to friction during the initial steering phase, as described above.

Further, the step S120 of controlling the driving part of the vehicle based on the information detected by the sensor may include the step of adjusting the damping gain that acts as a resistance to movement of the steering wheel based on input information from the driver regarding steering of the steering wheel.

Specifically, the step of adjusting a damping gain that acts as a resistance to movement of the steering wheel based on input information from the driver regarding steering of the steering wheel may be performed by the damping control module 114.

More specifically, the damping gain may be variably controlled based on steering angular velocity information, among other driver input information related to steering of the steering wheel sensed by the sensing module 111.

For example, an EPS control method for improving steering performance in accordance with one embodiment of the disclosed invention may variably control the damping gain based on steering angular velocity information.

More specifically, the steering angular velocity information of the vehicle for controlling the damping gain may be divided into a first section, a second section, and a third section.

Accordingly, the damping control module 114 may adjust the damping gain based on the triplicated steering angular velocity information.

Specifically, the first section may be defined as the interval from when the steering angular velocity information starts at 0 rev/s until the first reference steering angular velocity information is reached.

In this case, the first reference steering angular velocity information, which is the basis for distinguishing between the first and second sections, may have a value of more than 0.05 rev/s and less than or equal to 0.15 rev/s.

Preferably, the first reference steering angular velocity information, which is the criterion for distinguishing between the first and second sections, may have a value of 0.1 rev/s.

For example, if the steering angular velocity information is in the first section, the damping gain controlled by the damping control module 114 may increase as the steering angular velocity increases.

Further, the second section may be defined as the section from when the steering angular velocity information is the first reference steering angular velocity information to when the second reference steering angular velocity information is reached.

In this case, the second reference steering angular velocity information, which is the basis for distinguishing between the second and third sections, may have a value of more than 0.25 rev/s and less than or equal to 0.35 rev/s.

Preferably, the second reference steering angular velocity information, which is the criterion for distinguishing between the second and third sections, may have a value of 0.3 rev/s.

For example, if the steering angular velocity information corresponds to a second section, the damping gain controlled by the damping control module 114 may decrease as the steering angular velocity increases.

Further, the third section may be defined as the section where the steering angular velocity information is greater than or equal to the second reference steering angular velocity information.

For example, if the steering angular velocity information is in the third section, the damping gain controlled by the damping control module 114 may decrease as the steering angular velocity increases.

Thus, the EPS control method and device for improving steering performance according to one embodiment of the disclosed invention has the advantage of providing superior steering feel by applying a variable damping gain based on steering angular velocity.

Furthermore, the EPS control method and device for improving steering performance according to one embodiment of the disclosed invention has the advantage of achieving both improved steering feel and stability by considering influencing factors that are in a complex relationship with each other.

Furthermore, the EPS control method and device for improving steering performance according to one embodiment of the disclosed invention has the advantage of being able to utilize the architecture of an existing EPS control system to achieve the goal of improving steering feel.

The devices described above may be implemented as hardware components, software components, and/or a combination of hardware and software components. For example, the devices and components described in the embodiments may be implemented using one or more general purpose computers or special purpose computers, such as, for example, a processor, controller, arithmetic logic unit (ALU), digital signal processor, microcomputer, field programmable array (FPA), programmable logic unit (PLU), microprocessor, or any other device capable of executing and responding to instructions. The processing device may include an operating system (OS) and one or more software applications executable on the operating system. The processing device may also access, store, manipulate, process, and generate data in response to the execution of the software. For ease of understanding, a processing device is sometimes described as utilizing a single processing element, but one of ordinary skill in the art will recognize that a processing device may include a plurality of processing elements and/or a plurality of types of processing elements. For example, a processing device may include a plurality of processors or one processor and one controller. Other processing configurations are also possible, such as parallel processors.

Software may include computer programs, code, instructions, or one or more combinations thereof, and may configure a processing device to operate as desired or may independently or collectively instruct a processing device. The software and/or data may be embodied in any type of machine, component, physical device, virtual equipment, computer storage medium, or device, for interpretation by a processing device or for providing instructions or data to a processing device. Software may also be distributed on networked computer systems and stored or executed in a distributed manner. The software and data may be stored on one or more computer-readable recording media.

The methods according to embodiments may be implemented in the form of program instructions that may be executed through various computer means and recorded on a computer-readable medium. The computer-readable medium may include program instructions, data files, data structures, and the like, singly or in combination. The program instructions recorded on the medium may be specifically designed and configured for the embodiment or may be known and available to those skilled in the computer software art. Examples of computer-readable recording media include magnetic media, such as hard disks, floppy disks, and magnetic tape; optical media, such as CD-ROMs and DVDs; magneto-optical media, such as floppy disks; and hardware devices specifically configured to store and execute program instructions, such as ROMs, RAMs, flash memory, and the like. Examples of program instructions include machine language code, such as that created by a compiler, as well as high-level language code that can be executed by a computer using an interpreter or the like.

Although embodiments have been described above by way of limited examples and drawings, various modifications and variations from the above description are possible to those of ordinary skill in the art. For example, the described techniques may be performed in a different order than described, and/or components of the described systems, structures, devices, circuits, etc. may be combined or combined in a different form than described, or substituted or replaced by other components or equivalents, and still achieve suitable results. Therefore, other implementations, other embodiments, and equivalents of the claims are also within the scope of the following patent claims.

What is claimed is:

1. An EPS control device for improved steering performance comprising:
a sensing module detecting information about a traveling speed of a vehicle and input information from a driver about steering a steering wheel;
a main assist module controlling a driving part of the vehicle based on information detected by the sensing module;
a high frequency assist module adjusting a high frequency assist gain based on the input information from the driver about steering the steering wheel; and
a damping control module adjusting a damping gain that acts as a resistance to movement of the steering wheel based on the input information from the driver about steering the steering wheel.

2. The EPS control device according to claim 1,
wherein the information about the traveling speed of the vehicle includes a lateral acceleration information of the vehicle, and
wherein the information from the driver about steering the steering wheel includes a steering torque information, a steering angle information, and a steering angular velocity information of the steering wheel.

3. The EPS control device according to claim 2,
wherein the damping gain is variably controlled based on the steering angular velocity information.

4. The EPS control device according to claim 3,
wherein the steering angular velocity information is divided into a first section, a second section, and a third section, and
wherein the damping gain is adjusted based on the steering angular velocity information divided into three sections.

5. The EPS control device according to claim 4,
wherein the steering angular velocity information corresponds to the first section, the damping gain increases as the steering angular velocity increases.

6. The EPS control device according to claim 4,
wherein the steering angular velocity information corresponds to the second section and the third section, the damping gain decreases as said steering angular velocity increases.

7. The EPS control device according to claim 4,
wherein a first reference steering angular velocity information separating the first section from the second section has a value of more than 0.05 rev/s and less than 0.15 rev/s.

8. The EPS control device according to claim 4,
wherein a second reference steering angular velocity information separating the second section from the third section has a value of more than 0.25 rev/s and less than 0.35 rev/s.

9. The EPS control device according to claim 2,
wherein the high frequency assist module increases the high frequency assist gain as the steering torque passed through a high frequency filter increases, based on the steering torque information of the steering wheel.

10. An EPS control method for improved steering performance comprising:
a step of sensing that detects information about a traveling speed of a vehicle and input information from a driver about steering a steering wheel;
a step of main assist that controls a driving part of the vehicle based on information detected by the step of sensing;
a step of high frequency assist that adjusts a high frequency assist gain based on the input information from the driver about steering the steering wheel; and
a step of damping control that adjusts a damping gain that acts as a resistance to movement of the steering wheel based on the input information from the driver about steering the steering wheel.

11. The EPS control method according to claim 10,
wherein the information about the traveling speed of the vehicle includes a lateral acceleration information of the vehicle, and
wherein the information from the driver about steering the steering wheel includes a steering torque information, a steering angle information, and a steering angular velocity information of the steering wheel.

12. The EPS control method according to claim 11,
wherein the damping gain is variably controlled based on the steering angular velocity information.

13. The EPS control method according to claim 12,
wherein the steering angular velocity information is divided into a first section, a second section, and a third section, and
wherein the damping gain is adjusted based on the steering angular velocity information divided into three sections.

14. The EPS control method according to claim 11,
wherein the step of high frequency assist includes a step of increasing the high frequency assist gain as the steering torque passed through a high frequency filter increases, based on the steering torque information of the steering wheel.

15. An EPS control device for improved steering performance comprising:
a sensing module detecting a lateral acceleration information of a vehicle, a steering torque information, a steering angle information, and a steering angular velocity information of a steering wheel;
a main assist module controlling a driving part of the vehicle based on information detected by the sensing module; and
a damping control module variably adjusting a damping gain that acts as a resistance to movement of the steering wheel as a value of the steering angular velocity information is varied, and setting the damping gain to zero when the steering angular velocity information has a value of 0 rev/s.
